(19) United States
(12) Patent Application Publication
(10) Pub. No.: US 2017/0098010 A1
(43) Pub. Date: Apr. 6, 2017

(54) DATA INTEGRATION APPARATUS AND DATA INTEGRATION METHOD

(71) Applicant: Hitachi, Ltd., Tokyo (JP)

(72) Inventors: Nobuaki KOHINATA, Tokyo (JP); Yasunori KANEDA, Tokyo (JP)

(21) Appl. No.: 15/127,829

(22) PCT Filed: Sep. 25, 2014
(86) PCT No.: PCT/JP2014/075391

§ 371 Date: Sep. 21, 2016

(51) Int. Cl. G06F 17/30

(52) U.S. Cl. CPC G06F 17/30952; G06F 17/30091

(57) ABSTRACT

In a data integration apparatus, when an interface receives data having an order relationship at each of a plurality of reception times, a controller stores, in a first storage unit, normal data that is data in an order belonging to a selected reception time among pieces of data received by the interface and an unreceived order that is an order not corresponding to any data order of data received at the selected reception time among a plurality of orders belonging to the selected reception time.

### TECHNICAL FIELD

The present invention is generally related to a technique for receiving and integrating data.

### BACKGROUND ART

Data integration apparatuses which integrate and analyze data periodically transmitted from each of a large number of sensors are being developed. However, in real environments, for example, a temporary failure of a sensor or the like may result in data transmitted from the sensor having an abnormal value or a fault on a communication network or the like may cause failure of reception of data by a data integration apparatus. PTL 1 discloses a technique for eliminating an abnormal value included in time-series data and correcting an abnormal value or an unreceived portion.

### CITATION LIST

### Patent Literature

### [PTL 1]

Japanese Patent No. 5119022

### SUMMARY OF INVENTION

### Technical Problem

There are cases where, after a determination is made that a data integration apparatus has failed to receive data, the data is transmitted to the data integration apparatus after a delay. The delay time may have various lengths. For example, when a communication network becomes temporarily congested and the congestion is resolved after several minutes to several hours, the delay time may possibly be the time from occurrence to resolution of the congestion of the communication network (in other words, several minutes to several hours). In addition, for example, when a failure occurs in a transmission system of a certain sensor and the failure is resolved after several days to several months (or several years), the delay time of data from the sensor may possibly be the time from occurrence to resolution of the failure (in other words, several days to several months (or several years)) and, furthermore, a data integration apparatus may possibly receive a large number of pieces of data that were left untransmitted from the sensor after the resolution of the failure. Problems of this type may also occur in at least one of a case where a plurality of data sources are other than a plurality of sensors, a case where data is irregularly transmitted from a data source, and a case where a plurality of pieces of data from a data source have an order relationship other than a time series.

In consideration thereof, an object of the present invention is to provide a data integration apparatus and a data integration method for appropriately processing data transmitted after a delay. In addition, another object of the present invention is to provide a data integration apparatus and a data integration method for appropriately storing data transmitted after a delay in a portion where the data could not be previously received.

### Solution to Problem

A data integration apparatus according to an embodiment includes:

an interface which receives data having an order relationship at each of a plurality of reception times; and
a controller which stores, in a first storage unit, normal data that is data in an order belonging to a selected reception time among pieces of data received by the interface and an unreceived order that is an order not corresponding to any data order of data received at the selected reception time among a plurality of orders belonging to the selected reception time.

When an order of data received after the selected reception time matches any of unreceived orders stored in the first storage unit, the controller may store delayed data that is data received after the selected reception time in the first storage unit.

### Advantageous Effects of Invention

According to the present invention, the data integration apparatus can appropriately process data transmitted after a delay. In addition, according to the present invention, the data integration apparatus can appropriately store data transmitted after a delay in a portion where the data could not be previously received. Accordingly, the data integration apparatus can perform an analysis using the data transmitted after a delay.

### BRIEF DESCRIPTION OF DRAWINGS

FIG. 1 is a schematic diagram showing an outline of operations of a data integration apparatus.

FIG. 2 shows a configuration example of hardware of a data integration apparatus.

FIG. 3 shows a configuration example of functions of a data integration apparatus.

FIG. 4 shows a configuration example of a normal table in a DB (database).

FIG. 5 shows a configuration example of a delay table in a DB (database).

FIG. 6 is a flow chart showing an outline of processes according to a present embodiment.

FIG. 7 is a flow chart showing an example of a reception process.

FIG. 8 is a flow chart showing an example of an import process.

FIG. 9 is a flow chart showing an example of a data storage process.

FIG. 10 is a flow chart showing an example of a data update process.

FIG. 11 is a flow chart showing an example of a data reference process.

FIG. 12 is a schematic diagram showing an example of a measured data GUI (graphical user interface).

### DESCRIPTION OF EMBODIMENT

Hereinafter, an embodiment will be described. Moreover, although information may be described below using expressions such as an “x×x table”, the information may be expressed without using data structures such as a table. Therefore, in order to show that information is not dependent on data structure, for example, an “x×x table” may sometimes be referred to as “xxx information”.

In addition, although a description may be given below using an “xxx unit” as a subject, the “xxx unit” may be constituted by a computer program (referred to as a “program”). Since a program performs a prescribed process using a memory and a communication port (a network I/F) by being executed by a processor, a processor or a CPU may be used instead as a subject in the description. In addition, a process disclosed using a program as a subject may be considered a process performed by a computer such as a monitoring system. Furthermore, a program may be partially or entirely realized by dedicated hardware. Moreover, various programs may be installed in each computer from a program distribution server or via a storage medium that can be read by a computer.

In addition, in the following description, reference signs of a plurality of elements of a same type are combinations of a same parent number and a different child sign. When describing elements of a same type without distinguishing among the elements, only the parent number of the reference sign may be used, and when describing elements while distinguishing among the elements, an entire reference sign may be used. Furthermore, in the following description, when describing elements of a same type while distinguishing the elements from one another, reference signs such as “xxx 320a” and “xxx 320b” will be used. However, when describing elements of a same type without distinguishing the elements from one another, only a shared number among the reference signs such as “xxx 320” may sometimes be used.

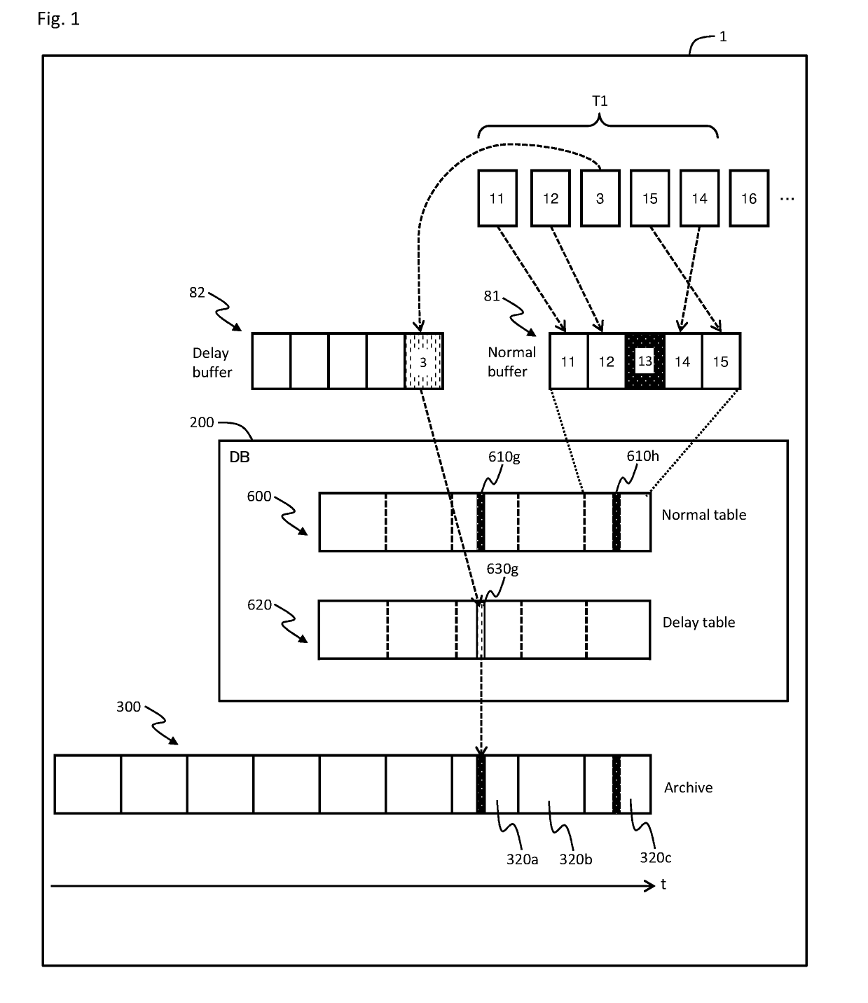

FIG. 1 is a schematic diagram showing an outline of operations of a data integration apparatus 1.

The data integration apparatus 1 includes a controller, a reception unit, a first storage unit, and a second storage unit. The second storage unit may be configured such that an amount of storable data is larger than the first storage unit. The first storage unit is, for example, a DB (database) 200 or a first storage apparatus as the DB 200 and the second storage unit is, for example, an archive 300 or a second storage apparatus as the archive 300. The controller is capable of inputting data to and outputting data from the DB 200 and inputting files to and outputting files from the archive 300. At least one of the first storage unit and the second storage unit may exist outside of the data integration apparatus 1. The archive 300 may be an example of a file system (for example, a logical space for storing files) and, in such a case, the second storage apparatus may be a storage apparatus which provides the file system.

The reception unit receives packet data via a communication network. Packet data includes a plurality of pieces of data having an order relationship.

The controller extracts a plurality of pieces of data having an order relationship from packet data received by the reception unit. The controller stores information representing a correspondence relationship between a section of orders and a reception time that is a time at which data in an order belonging to the order section (an order included in the order section) is received. The example shown in FIG. 1 indicates that an order section “11 or more and less than 16” and a reception time T1 correspond to each other. It is assumed that an order section according to the present embodiment includes an order at a start point of the section but does not include an order at an end point of the section.

For each of a plurality of pieces of extracted data having an order relationship, the controller determines whether or not an order of the data belongs to an order section corresponding to a selected reception time (hereinafter, sometimes referred to as a “target order section”). In this case, a “reception time” refers to one time length (for example, 300 seconds) such as a period. Therefore, a plurality of reception times exist, and a “selected reception time” refers to a reception time selected from the plurality of reception times. A reception time may be selected by, for example, a user.

The controller stores data having an order belonging to a target order section (hereinafter, referred to as “normal data”) in a normal buffer (a buffer used as a storage destination for normal data) 81. For example, in FIG. 1, pieces of data with orders of “11”, “12”, “3”, “15”, and “14” are received within the selected reception time T1. Therefore, the controller respectively stores pieces of data with orders of “11”, “12”, “15”, and “14” belonging to the order section “11” or more and less than “16” which corresponds to the selected reception time T1 in the normal buffer 81 as normal data. Accordingly, the controller can store only data received at normal timings (in other words, data received without delay) in the normal buffer 81.

In addition, the controller identifies an order not corresponding to any data order of the plurality of pieces of extracted data (hereinafter, referred to as an “unreceived order”) among the plurality of orders belonging to the target order section. Data in an unreceived order may also be described as data which should have been received within a selected reception time but was not received. For example, in FIG. 1, the data integration apparatus 1 had been unable to received data in the order “13” within the reception time T1 corresponding to the selected order section “11” or more and less than “16”. Therefore, the controller stores null data corresponding to the unreceived order “13” in the normal buffer 81. Accordingly, the controller can manage an order of data which had not been received at normal timings.

The controller may generate interpolated data corresponding to an unreceived order based on a prescribed interpolation process and store the interpolated data in the normal buffer 81. For example, in FIG. 1, the controller generates interpolated data corresponding to the unreceived order “13” based on a prescribed interpolation process and stores the interpolated data in the normal buffer 81. Accordingly, even when delayed data (a description on “delayed data” will be given later) corresponding to an unreceived order cannot be received, the controller can perform data analysis by applying interpolated data. Moreover, “interpolated data” refers to data for interpolating missing data among the plurality of pieces of data having an order relationship and may be, for example, data generated based on pieces of data in orders preceding and following an unreceived order.

Consequently, the plurality of pieces of data in the normal buffer 81 (hereinafter, may sometimes be referred to as a “normal data group”) may sometimes be all normal data or may sometimes be a mixture of normal data and data with an unreceived order (null data or interpolated data). The controller may sort the plurality of pieces of data in the normal buffer 81 in order. For example, in FIG. 1, the controller sorts the normal pieces of data with the orders “15” and “14” in the normal buffer 81. Accordingly, the plurality of pieces of data in the normal buffer 81 are arranged in order.

Next, the controller stores the normal data group stored in the normal buffer 81 in the DB 200 and the archive 300. Since data is stored in both the first storage unit and the second storage unit, fault tolerance of the data is increased.

In the DB 200, data and an order thereof are associated with each other. There is an upper limit to an amount of data that can be stored in the DB 200. When the amount of data stored in the DB 200 reaches the upper limit, the controller is unable to newly store data in the DB 200. In this case, the controller may preferentially delete data with a lower order from the DB 200. Accordingly, data with relatively high reference frequency or, in other words, data with a higher order can be retained in the DB 200 which enables retrieval at a higher speed than the archive 300.

On the other hand, there may be data with an order that does not belong to an order section corresponding to a selected reception time. Usually, such data is data having a lower order than any of the orders belonging to the corresponding order section. In other words, the data is data which should have been received within the selected reception time but was received after the selected reception time. Hereinafter, such data received after a delay will be referred to as “delayed data”. The controller stores delayed data in a delay buffer (a buffer used as a storage destination for delayed data) 82. For example, in FIG. 1, the data in the order “3” is outside of range of the order section “11 to 15” which corresponds to the selected reception time T1 and is data with a lower order than any of the orders belonging to the order section “11 to 15”. Therefore, the controller stores the data in the order “3” in the delay buffer 82 as delayed data. Accordingly, the controller can store only delayed data in the delay buffer 82.

In addition, the controller stores one or more pieces of delayed data (a “delayed data group”) stored in the delay buffer 82 in the DB 200. In the DB 200, normal data and delayed data may be managed so as to be distinguishable from each other. For example, the DB 200 includes a normal table 600 that is a table to be used as a storage destination for normal data and delayed table 620 to be used as a storage destination for delayed data, and the controller stores a normal data group in the normal table 600 and stores a delayed data group in a delay table 620. For example, in FIG. 1, the controller stores the delayed data in the order “3” which is being stored in the delay buffer 82 in the delay table 620. Accordingly, the controller can manage normal data and delayed data so as to be distinguishable from each other. Therefore, the user can select whether or not delayed data is to be selected when analyzing data.

The controller may also store delayed data in the archive 300. Specifically, the controller may search for and acquire (read) a file including data in a same unreceived order as an order of delayed data from the archive 300 and replace the data in the same unreceived order as the order of the delayed data in the acquired file with the delayed data. At this point, the controller may store information indicating that delayed data has already been received with respect to the same unreceived order as the order of the delayed data in the DB 200. In addition, the controller may have the user select whether or not to store the delayed data in the archive 300.

For example, in FIG. 1, a file 320a stored in the archive 300 includes data of an unreceived order “3”. Therefore, the controller acquires the file 320a from the archive 300. Subsequently, the controller generates a file by replacing the data of the unreceived order “3” in the acquired file 320a with the delayed data in the order “3”. Furthermore, the controller replaces the file 320a in the archive 300 with the generated file. At the same time, the controller changes a flag (value) corresponding to the unreceived order “3” in the normal table 600 from a value indicating delay to a value indicating that delayed data has been received.

The controller need not store, in the delay table 620, delayed data of which an order does not match any of the unreceived orders in the normal table 600 in the delayed data group stored in the delay buffer 82. For example, in a configuration in which data with a lower order is preferentially deleted from the normal table 600, the controller need not store, in the delay table 620, delayed data in a lower order than a lowest order stored in the normal table 600 in the delayed data stored in the delay buffer 82. Accordingly, delayed data in a lower (older) order than the lowest order stored in the normal table 600 is not even stored in the archive 300.

The controller need not store, in the delay table 620, delayed data of which an order is the same as an order of normal data already stored in the normal table 600 in the delayed data stored in the delay buffer 82. In other words, for a same order, normal data stored in the normal table 600 is prioritized over delayed data.

When the controller receives, after a prescribed time has lapsed from a reception time corresponding to an unreceived order (specifically, after a prescribed time has lapsed from a prescribed time point (for example, an end time point of the reception time) of the reception time corresponding an order section to which the unreceived order belongs), delayed data corresponding to the unreceived order, the controller need not store the delayed data in the delay table 620. In other words, the controller may discard delayed data satisfying such discard conditions. As the “prescribed time” described above, a storage period (to be described later) can be adopted. While normal data received within a reception time corresponding to an unreceived order is deleted from the DB 200 once the storage period elapses from the reception time (or a measurement time point of the normal data), by adopting the discard conditions described above, storage in the DB 200 of delayed data satisfying conditions for deletion from the DB 200 can be avoided.

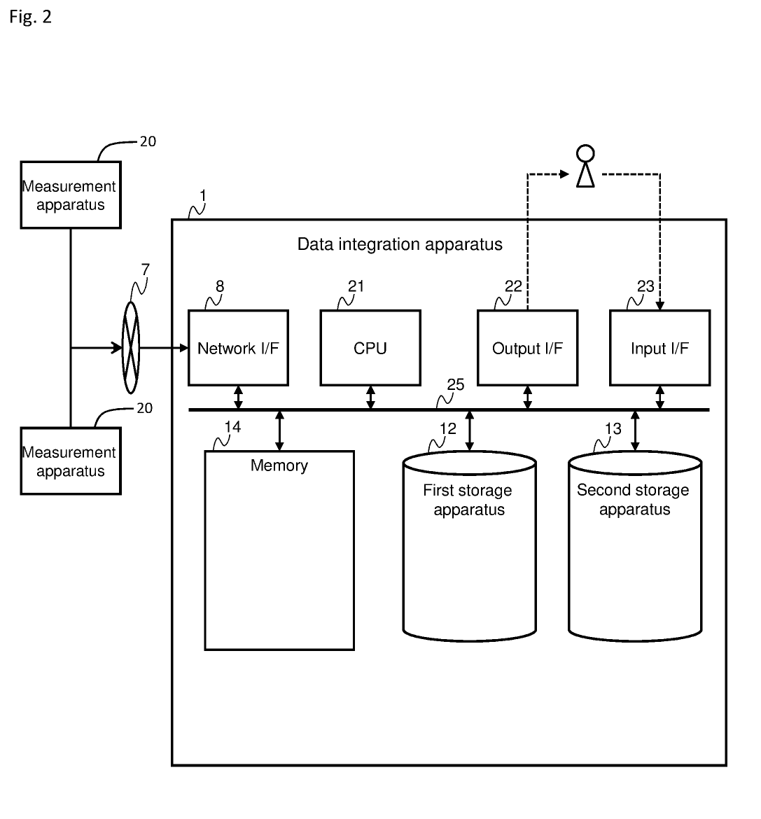

FIG. 2 shows a configuration example of hardware of the data integration apparatus 1.

The data integration apparatus 1 receives measured data transmitted from moment to moment from each of a plurality of measurement apparatuses 20 and integrates the received measured data.

For example, a measurement apparatus 20 in a wide-area power protection solution measures voltage, frequency, and the like at a prescribed period and, from moment to moment, transmits measured data including a measurement time thereof and a measured value thereof to the data integration apparatus 1. For example, a measurement apparatus 20 in a traffic infrastructure status monitoring solution measures an amount of traffic and the like at a prescribed period and, from moment to moment, transmits measured data including a measurement time thereof and a measured value thereof to the data integration apparatus 1.

The data integration apparatus 1 includes, as hardware, a network I/F 8, a CPU 21, a memory 14, a first storage apparatus 12, a second storage apparatus 13, an input I/F 23, and an output I/F 22. The elements 9, 21, 14, 12, 13, 23, and 22 are coupled by an internal bus 25 which enables bi-directional data transmission and reception. An example of the internal bus 25 is a PCIe (PCI express). At least one of the first storage apparatus 12 and the second storage apparatus 13 may exist outside of the data integration apparatus 1.

Data is integrated in the first storage apparatus 12 and the second storage apparatus 13. An example of the first storage apparatus 12 and the second storage apparatus 13 is a storage medium such as an HDD (hard disk drive) or an SSD (solid state drive). At least one of the first storage apparatus 12 and the second storage apparatus 13 may be a large-scale apparatus such as a disk array apparatus including a plurality of storage media.

The network I/F (interface) 8 is an I/F for coupling the data integration apparatus 1 to a communication network 7. An example of the network I/F 8 is an NIC (network interface card).

The CPU 21 realizes various functions described in the present embodiment by executing a programs stored in the memory 14.

The memory 14 stores programs, data, and the like. Examples of the memory 14 include a DRAM (dynamite random access memory), an MRAM (magnetic random access memory), and a FeRAM (ferroelectric random access memory).

The input I/F 23 is an I/F for coupling an input device to the data integration apparatus 1. A command or the like input by the user by operating the input device is input to the CPU 21 or the like via the input I/F 23. Examples of an input device include a keyboard, a mouse, and a microphone.

The output I/F 22 is an I/F for coupling an output device to the data integration apparatus 1. A processing result of the data integration apparatus 1, a GUI, or the like is output to the output device via the output I/F 22. Examples of an output device include a display and a speaker. Moreover, the network I/F 8 or another network I/F may be adopted in place of the input I/F 23 and the output I/F 22, and the CPU 21 may receive information input from a computer used by the user or may output information for display to the computer used by the user via the network I/F 8 or another network I/F.

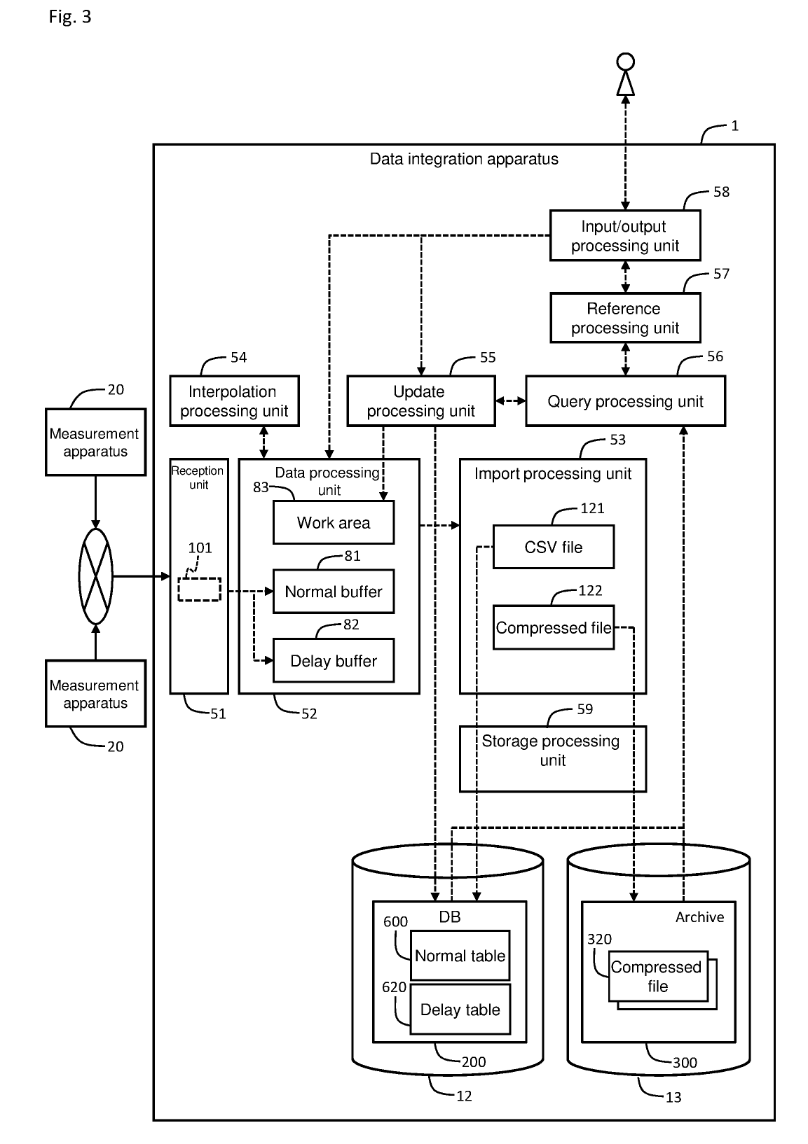

FIG. 3 shows a configuration example of functions of the data integration apparatus 1.

The data integration apparatus 1 includes, as functions, a reception unit 51, a data processing unit 52, an import processing unit 53, a query processing unit 56, an update processing unit 55, a reference processing unit 57, an input/output processing unit 58, an interpolation processing unit 54, and a storage processing unit 59. Among these functions, the reception unit 51 may be realized by the network I/F 8 and functions other than the reception unit 51 may be realized by having the CPU 21 executes a program stored in the memory 14. All of or apart of these functions may be realized by a dedicated hardware circuit (for example, an ASIC (application specific integrated circuit)).

The data integration apparatus 1 includes the DB 200 as an example of the first storage unit and the archive 300 as an example of the second storage unit. The DB 200 and the archive 300 may be configured in storage apparatuses that physically differ from each other or may be configured in a same storage apparatus. For example, the DB 200 may be stored in the first storage apparatus 12 and the archive 300 may be stored in the second storage apparatus 13. This is done to increase fault tolerance with respect to data.

The reception unit 51 controls the network I/F 8 and receives packet data 101 including measured data transmitted from the measurement apparatus 20. The packet data 101 may include a plurality of pieces of measured data.

For each reception time, the data processing unit 52 extracts measured data from the packet data 101 received by the reception unit 51 in the reception time. In addition, the data processing unit 52 determines whether or not the measurement time point of the measured data belongs to a time interval corresponding to the reception time. In this case, a measurement time point corresponds to an “order” in the description given with reference to FIG. 1, and a time interval corresponds to an “order section” in the description given with reference to FIG. 1.

When the data processing unit 52 determines that the measurement time point belongs to the time interval corresponding to the selected reception time (hereinafter, referred to as a “target time interval”), the data processing unit 52 stores the measured data in the normal buffer 81. In this case, measured data having a measurement time point belonging to a target time interval will be referred to as “normal measured data”. In addition, after the reception time ends, the data processing unit 52 identifies a measurement time point of measured data that could not be received within the target time interval as an unreceived time point. In this case, an unreceived time point corresponds to an “unreceived order” in the description given with reference to FIG. 1. Since a measurement time point is periodic, an unreceived time point can be uniquely identified.

For example, let us assume that a reception time is 5 minutes from a given time point, a time interval corresponding to the reception time is “0 hours 0 minutes 0 seconds to 0 hours 5 minutes 0 seconds”, and a period of a measurement time point is 1 second. When the data processing unit 52 receives measured data of a measurement time point “0 hours 0 minutes 1 second” within the reception time, since the measurement time point “0 hours 0 minutes 1 second” belongs to the time interval “0 hours 0 minutes 0 seconds to 0 hours 5 minutes 0 seconds”, the data processing unit 52 stores the measured data in the normal buffer 81 as normal measured data. In addition, after the reception time ends, the data processing unit 52 identifies a measurement time point that could not be received within the target time interval. For example, when measured data of measurement time points “0 hours 0 minutes 3 seconds” and “0 hours 0 minutes 4 seconds” could not be received within the reception time, the data processing unit 52 respectively identifies the measurement time points “0 hours 0 minutes 3 seconds” and “0 hours 0 minutes 4 seconds” as unreceived time points. A reception time and a time interval corresponding thereto may be the same or may differ from each other. For example, a start time point of a reception time may arrive after a delay of a prescribed time from a start time point of a time interval corresponding to the reception time. This is because a time lag may occur between measurement of data and the arrival of packet data including the measured data at the data integration apparatus 1.

The interpolation processing unit 54 may interpolate measured data corresponding to an unreceived time point based on measured data stored in the normal buffer 81. An example of interpolation is a linear interpolation method.

The data processing unit 52 may sort a plurality of pieces of measured data (including interpolated measured data) in an order of measurement time points (including unreceived time points) in the normal buffer 81.

After the reception time ends, the data processing unit 52 issues an indication to the import processing unit 53 to perform an import process of a normal measured data group in the normal buffer 81. The plurality of pieces of measured data belonging to a normal measured data group may sometimes be all normal measured data or may sometimes be a mixture of normal measured data and measured data of an unreceived time point (null data or interpolated data).

When the data processing unit 52 determines that the measurement time point belongs to the time interval corresponding to the selected reception time (hereinafter, referred to as a “target time interval”), the data processing unit 52 stores the measured data in the delay buffer 82. In this case, measured data having a measurement time point not included in a target time interval will be referred to as “delayed measured data”.

For example, let us assume that a target time interval is “0 hours 10 minutes 0 seconds to 0 hours 15 minutes 0 seconds”. When the data processing unit 52 receives measured data of a measurement time point “0 hours 0 minutes 3 seconds” within the reception time, the data processing unit 52 stores the measured data (delayed measured data) in the delay buffer 82.

When a prescribed number N (where N is a positive integer) of more of pieces of delayed measured data is stored in the delay buffer 82, the data processing unit 52 may issue an indication to the import processing unit 53 to import a delayed measured data group in the delay buffer 82.

When a measured data group in which interpolated data (or null data) corresponding to an unreceived time point is replaced with delayed measured data (referred to as a “replaced measured data group”) is stored in a work area 83, the data processing unit 52 issues an indication to the import processing unit 53 to import the replaced measured data group in the work area 83.

Based on an indication from the data processing unit 52, the import processing unit 53 converts the normal measured data group in the normal buffer 81 into a format that enables detection of a data element to be registered in the DB 200 and a format that enables storage in the archive 300. For example, the import processing unit 53 converts the normal measured data group in the normal buffer 81 into a CSV (comma separated value) file 121 which is an example of a file that enables detection of a data element to be registered in the normal table 600 of the DB 200. In addition, the import processing unit 53 converts the normal measured data group in the normal buffer 81 into a compressed file 122 which is an example of a file that enables storage in the archive 300. An example of the compressed file 122 is a ZIP file. The import processing unit 53 may compress the CSV file 121 to generate the compressed file 122. In addition, the import processing unit 53 issues an indication to the storage processing unit 59 to perform storage.

Based on an indication from the data processing unit 52, the import processing unit converts the delayed measured data group in the delay buffer 82 into a format that enables detection of a data element to be registered in the DB 200. Specifically, for example, the delayed measured data group in the delay buffer 82 may be converted into the CSV file 121 in a similar manner to the normal measured data group.

Based on an indication from the data processing unit 52, the import processing unit 53 converts the replaced measured data group in the work area 83 into a format that enables storage in the archive 300. This format may be the compressed file 122 in a similar manner to the description given above.

Based on an indication from the import processing unit 53, the storage processing unit 59 stores measured data obtained from the CSV file 121 based on the normal measured data group in the normal table 600 and stores the compressed file 122 including the normal measured data group in the archive 300.

Based on an indication from the import processing unit 53, the storage processing unit 59 stores delayed data obtained from the CSV file 121 including the delayed measured data group in the delay table 620.

Based on an indication from the import processing unit 53, the storage processing unit 59 replaces an original compressed file 320 in the archive 300 with the compressed file 122 including replaced measured data.

The query processing unit 56 retrieves measured data matching a retrieval query from the DB 200 and the archive 300. The query processing unit 56 may preferentially perform retrieval from the DB 200. A retrieval query may be input by the user or may be automatically generated in the data integration apparatus 1 based on prescribed conditions. An example of a language for describing a retrieval query is SQL (Structured Query Language).

The update processing unit 55 replaces measured data of an unreceived time point with delayed measured data. The update processing unit 55 may perform this replacement without any indication from the user or may perform the replacement upon receiving an indication from the user. The update processing unit 55 acquires delayed measured data from the delay table 620 of the DB 200 via the query processing unit 56.

In addition, the update processing unit 55 acquires a measured data group in import units including measured data of a same unreceived time point as a measurement time point of the delayed measured data from the normal table 600 via the query processing unit 56. Alternatively, the update processing unit 55 acquires a compressed file 320 including measured data of a same unreceived time point as a measurement time point of the delayed measured data from the archive 300 via the query processing unit 56.

Furthermore, the update processing unit 55 generates a replaced measured data group in which the measured data of the unreceived time point is replaced with delayed measured data and stores the generated replaced measured data group in the work area 83. Accordingly, as described above, the compressed file 320 prior to replacement in the archive 300 is replaced with the compressed file 122 generated from the replaced measured data group in the work area 83 by the data processing unit 52 and the import processing unit 53.

The reference processing unit 57 refers to measured data in the DB 200 and the archive 300. For example, the reference processing unit 57 generates a retrieval query based on retrieval conditions input by the user via the input/output processing unit 58. In addition, the reference processing unit 57 acquires measured data matching the retrieval query from the DB 200 and the archive 300 via the query processing unit 56. The reference processing unit 57 may hand over the acquired measured data to the input/output processing unit 58.

The input/output processing unit 58 processes input by the user received via the input I/F 23. The input/output processing unit 58 outputs information generated in the data integration apparatus 1 to the user via the output I/F 22. For example, the input/output processing unit 58 generates a GUI and displays the GUI on a display. In addition, the input/output processing unit 58 may process input made on the GUI.

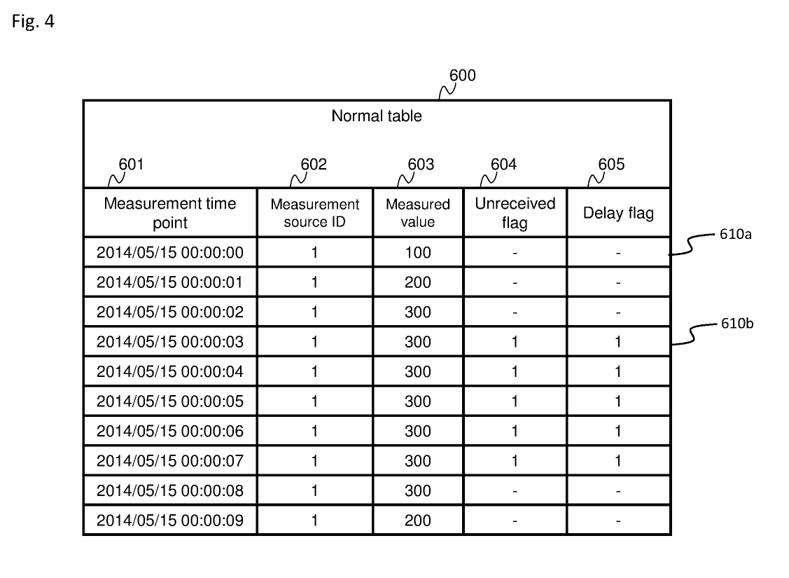

FIG. 4 shows a configuration example of the normal table 600 in the DB 200.

The normal table 600 manages normal measured data. Specifically, for example, the normal table 600 has a record for each piece of normal measured data, and the record includes a measurement time point 601, a measurement source ID 602, and a measured value 603 as field values. Furthermore, each record may include an unreceived flag 604 and a delay flag 605 as information related to normal measured data. Measured data such as normal measured data includes at least a measurement time point and a measured value. The measurement source ID 602 may be an ID identified based on a transmission source of measured data and may or may not be included in measured data.

The measurement time point 601 is a time point at which the measured value 603 had been measured. The measurement source ID 602 is identification information of the measurement apparatus 20 having measured the measured value 603 (for example, information identifying a position or a location of the measurement apparatus 20).

The measured value 603 is a value measured at the measurement time point 601 by the measurement apparatus 20 indicated by the measurement source ID 602. Alternatively, the measured value 603 is an interpolation value calculated by the interpolation processing unit 54. Moreover, “null” may be stored for the measured value 603 which has been neither measured nor interpolated.

The unreceived flag 604 is a flag indicating whether or not the measurement time point 601 is an unreceived time point. For example, the measurement time point 601 with “1” as the unreceived flag 604 indicates an unreceived time point. Therefore, the measured value 603 with “1” as the unreceived flag 604 is an interpolation value calculated by the interpolation processing unit 54.

The delay flag 605 is a flag indicating whether or not delayed measured data corresponding to the measurement time point 601 has already been acquired. For example, when the delay flag 605 is “1”, the delay flag 605 indicates that delayed measured data corresponding to the measurement time point 601 (in other words, an unreceived time point) has already been acquired.

In FIG. 4, the unreceived flag 604 of a record 610a is “null”. Therefore, the measured data represented by the record 610a is normal measured data received within the reception time.

In FIG. 4, the unreceived flag 604 of a record 610b is “1”. This indicates that the measured data represented by the record 610b could not be received within the reception time. In other words, the measurement time point 601 of the record 610b is an unreceived time point. In addition, the measured value “300” of the record 610b is an interpolation value.

The delay flag 605 of the record 610b is “1”. This indicates that delayed measured data corresponding to the measurement time point 601 (an unreceived time point) of the record 610b has already been acquired.

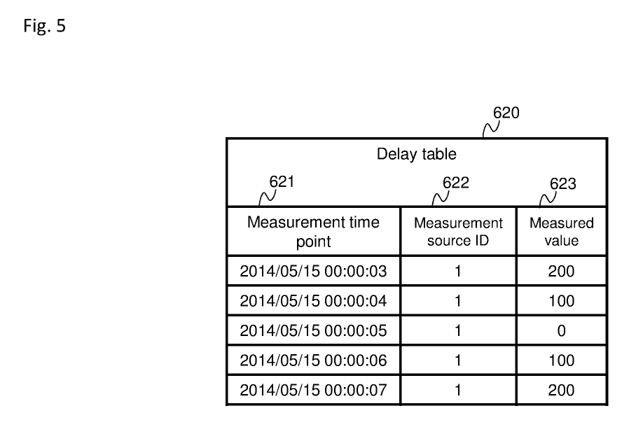

FIG. 5 shows a configuration example of the delay table 620 in the DB 200.

The delay table 620 manages delayed measured data. Specifically, for example, the delay table 620 has a record for each piece of delayed measured data. Each record includes field values 621, 622, and 623 which are respectively the same as the field values 601, 602, and 603 of a record in the normal table 600.

When delayed measured data is registered in the delay table 620, the delay flag 605 of the record 610b matching a measurement time point 621 of the delayed measured data in the normal table 600 is changed to “1”.

Examples of reasons for managing normal measured data and delayed measured data using different tables are as follows.

(1) Delayed measured data is not necessarily always reliable. For example, conceivably, delayed measured data having an intentionally falsified measured value may possibly be transmitted after a reception time ends.
(2) To enable the user to compare or select interpolated measured data and delayed measured data.

Moreover, while normal measured data and delayed measured data are distinguished from each other by using separate tables in the present embodiment, the data may be distinguished by other methods. For example, normal measured data and delayed measured data may be distinguished from each other by providing a field value that distinguishes normal measured data and delayed measured data from each other in a single table.

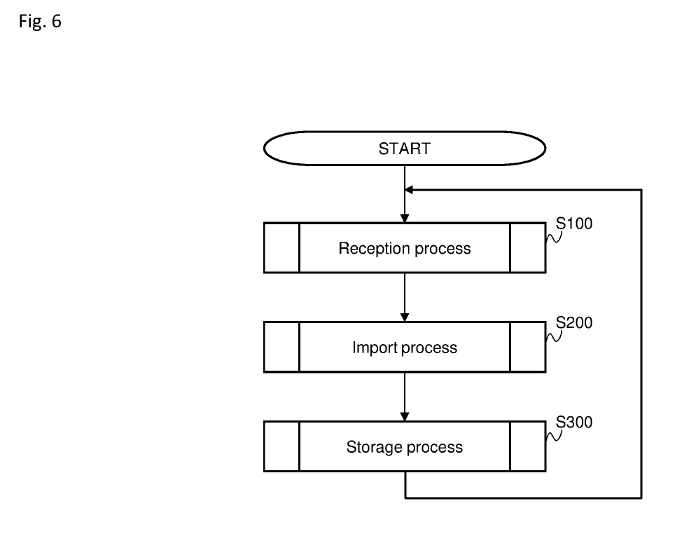

FIG. 6 is a flow chart showing an outline of processes according to the present embodiment.

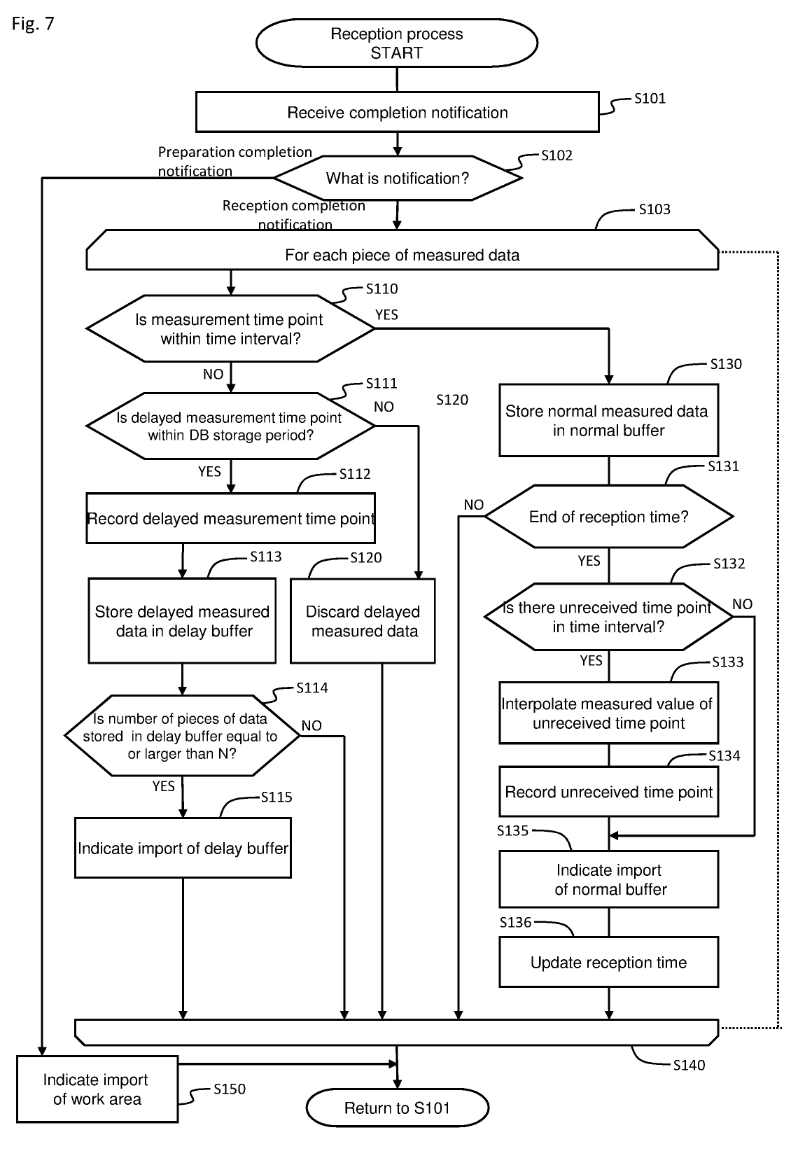

First, the data processing unit 52 performs a reception process (S100). Specifically, the data processing unit 52 processes measured data extracted from the packet data 101 received by the reception unit 51. Details of this process will be described with reference to FIG. 7.

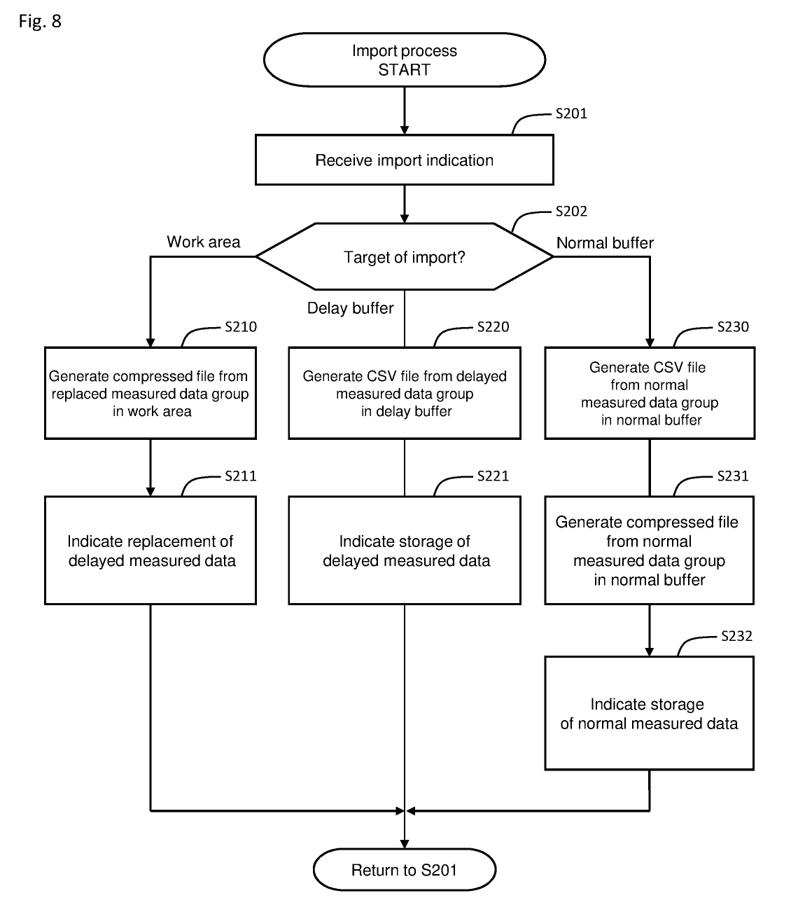

Next, the import processing unit 53 performs an import process with respect to measured data stored in the normal buffer 81, the delay buffer 82, or the work area 83 (S200). Specifically, the import processing unit 53 converts measured data into a CSV file that can be imported to the DB 200 and/or converts measured data into a compressed file that can be stored in the archive 300. Details of this process will be described with reference to FIG. 8.

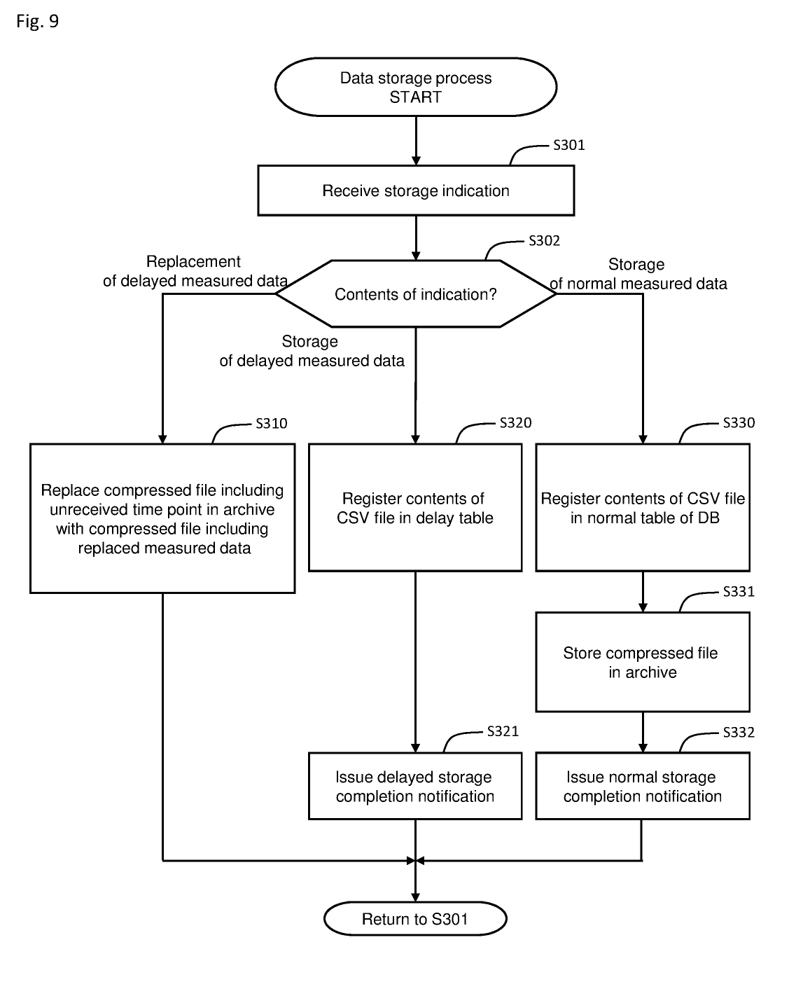

Subsequently, the storage processing unit 59 stores the converted CSV file and/or the converted compressed file in the DB 200 and/or the archive 300 (S300). Specifically, the storage processing unit 59 stores contents of the CSV file in the normal table 600 or the delay table 620 or stores the compressed file in the archive 300. Details of this process will be described with reference to FIG. 9.

The data integration apparatus 1 repetitively executes the processes of S100, S200, and S300. Hereinafter, details of S100, S200, and S300 will be described with reference to the drawings.

FIG. 7 is a flow chart showing an example of a reception process. This process corresponds to S100 in FIG. 6.

When the data processing unit 52 receives a reception completion notification or a preparation completion notification, the data processing unit 52 executes the following process (S101). A reception completion notification is notified from the reception unit 51. A preparation completion notification is notified from the update processing unit 55.

The data processing unit 52 determines which of a preparation completion notification and a reception completion notification has been received (S102).

When a “preparation completion notification” has been received (S102: preparation completion notification), the data processing unit 52 issues an indication to the import processing unit 53 for importing the work area 83 (S150) and returns to S101.

When a “reception completion notification” has been received (S102: reception completion notification), the data processing unit 52 executes processes of S103 to S140 below for each piece of extracted measured data (S103).

The data processing unit 52 determines whether or not a measurement time point of measured data belongs to a time interval corresponding to a present reception time (S110). In other words, the data processing unit 52 determines whether or not the measured data is not delayed measured data. This determination divides received measured data into normal measured data and delayed measured data.

Hereinafter, in the determination of S110, a case where the measurement time point of the measured data belongs to the time interval corresponding to the present reception time (S110: yes) will be described. In the following description, measured data of a measurement time point belonging to a time interval will be referred to as normal measured data in a similar manner to the description given earlier.

The data processing unit 52 stores normal measured data in the normal buffer 81 (S130). Next, the data processing unit 52 determines whether or not to end the present reception time (S131). For example, when the current time point represents a lapse of the present reception time (a period T1) or longer from a certain time point, the data processing unit 52 may determine to end the present reception time. Accordingly, normal measured data in an import unit is stored in the normal buffer 81.

When the data processing unit 52 determines not to end the present reception time (S131: no), the data processing unit 52 advances to S140. In S140, when there remains unprocessed measured data, the data processing unit 52 returns to S103, but when no unprocessed measured data remains, the data processing unit 52 returns to S101 (S140).

When the data processing unit 52 determines to end the present reception time (S131: yes), the data processing unit 52 determines whether or not there exists an unreceived time point which belongs to a time interval corresponding to the present reception time (S132). For example, the data processing unit 52 checks continuity of periods of measurement time points stored in the normal buffer 81 to determine whether or not there exists an unreceived time point.

When an unreceived time point which belongs to a time interval corresponding to the present reception time does not exist (S132: no), the data processing unit 52 advances to S135.

When there are one or more unreceived time points which belong to a time interval corresponding to the present reception time (S132: yes), the data processing unit 52 requests the interpolation processing unit 54 to calculate an interpolation value corresponding to the unreceived time point (S133). The interpolation processing unit 54 may calculate an interpolation value corresponding to the unreceived time point based on measured values of other measurement time points stored in the normal buffer 81. The data processing unit 52 stores measured data including the unreceived time point and the interpolation value in the normal buffer 81. Accordingly, the measured value of the unreceived time point is interpolated.

Subsequently, the data processing unit 52 records the unreceived time point in the memory 14 (S134) and advances to S135.

In S135, the data processing unit 52 issues an indication to the import processing unit 53 to import normal measured data stored in the normal buffer 81 (S135). In addition, the data processing unit 52 updates to a next reception time (S136) and advances to S140 described earlier.

Hereinafter, in the determination of S110, a case where the measurement time point of the measured data does not belong to the time interval corresponding to the present reception time (S110: no) will be described. Measured data of which a measurement time point is outside of the time interval will be hereinafter referred to as delayed measured data in a similar manner to the description given earlier.

The data processing unit 52 determines whether or not to store delayed measured data based on a delayed measurement time point (a measurement time point of the delayed measured data). For example, the data processing unit 52 determines whether or not the delayed measurement time point (the measurement time point of the delayed measured data) belongs to a period T2 in which measured data is stored in the DB 200 (referred to as a “DB storage period”) (S111). Alternatively, the data processing unit 52 may determine whether or not the delayed measurement time point belongs between the current time point and a time point preceding the current time point by a period T2 set by the user. In this case, the period T2 may be set as exemplified by “two years preceding the current time point” or may be set as exemplified by “from April 2004 to April 2006”.

When the data processing unit 52 determines not to store delayed measured data, the data processing unit 52 may discard the delayed data. For example, when the delayed measurement time point belongs to the DB storage period T2 (S111: no), the data processing unit 52 discards the delayed measured data (S120) and advances to S140 described earlier. In other words, when normal measured data corresponding to the delayed measurement time point only exists in the archive 300, the data processing unit 52 may discard the delayed measured data. Accordingly, delayed measured data of which a delayed measurement time point precedes the prescribed period T2 is discarded.

When the data processing unit 52 determines to store the delayed measured data, the data processing unit 52 stores the delayed measurement time point. For example, when the delayed measurement time point belongs to the DB storage period T2 (S111: yes), the data processing unit 52 stores the delayed measurement time point in the memory 14 (S112).

In addition, the data processing unit 52 stores the delayed measured data in the delay buffer 82 (S113). Subsequently, the data processing unit 52 determines whether or not the number of pieces of delayed measured data stored in the delay buffer 82 is equal to or larger than prescribed N (where N is a positive integer) (S114). Accordingly, N-number of pieces of delayed measured data are stored in the delay buffer 82.

When the number of pieces of delayed measured data stored in the delay buffer 82 is smaller than N (where N is a positive integer) (S114: no), the data processing unit 52 advances to S140 described earlier.

When the number of pieces of delayed measured data stored in the delay buffer 82 is equal to or larger than N (where N is a positive integer) (S114: yes), the data processing unit 52 issues an indication to the import processing unit 53 to import delayed measured data stored in the delay buffer 82 (S115). Subsequently, the data processing unit 52 advances to S140 described earlier.

FIG. 8 is a flow chart showing an example of an import process. This process corresponds to S200 in FIG. 6.

When the import processing unit 53 receives an import indication from the data processing unit 52 (S201), the import processing unit 53 determines whether a target of the import indication is any of the normal buffer 81 (normal measured data), the delay buffer 82 (delayed measured data), and the work area 83 (replaced measured data) (S202).

Hereinafter, in the determination of S202, a case where the target of the import indication is the normal buffer 81 (normal measured data) will be described. The import processing unit 53 generates a CSV file 121 suitable for registration in the normal table 600 from a normal measured data group stored in the normal buffer 81 (S230). The import processing unit 53 generates a compressed file 122 suitable for storage in the archive 300 from a normal measured data group stored in the normal buffer 81 (S231). In addition, the import processing unit 53 issues an indication to the storage processing unit 59 to store the CSV file 121 and the compressed file 122 (S232), and returns to S201.

Hereinafter, in the determination of S202, a case where the target of the import indication is the delay buffer 82 (delayed measured data) will be described. The import processing unit 53 generates a CSV file 121 suitable for registration in the delay table 620 from a delayed measured data group stored in the delay buffer 82 (S220). In addition, the import processing unit 53 issues an indication to the storage processing unit 59 to store the CSV file 121 (S221), and returns to S201.

Hereinafter, in the determination of S202, a case where the target of the import indication is the work area 83 (replaced measured data) will be described. The import processing unit 53 generates, for example, a compressed file 122 suitable for storage in the archive 300 from a replaced measured data group stored in the work area 83 (S210). In addition, the import processing unit 53 issues an indication to the storage processing unit 59 to store the compressed file 122 (S211), and returns to S201.

FIG. 9 is a flow chart showing an example of a data storage process.

When the storage processing unit 59 receives a storage indication from the import processing unit 53 (S301), the storage processing unit 59 determines whether a target of the storage indication is any of storage of normal measured data (the indication of S232), storage of delayed measured data (the indication of S221), and replacement of delayed measured data (the indication of S211) (S302).

Hereinafter, a case where storage of normal measured data is determined in S302 will be described. The storage processing unit 59 registers contents of the CSV file 121 generated in S230 and which includes normal measured data in the normal table 600 of the DB 200 (S330). The storage processing unit 59 stores the compressed file 122 generated in S231 and which includes normal measured data in the archive 300 (S331). Subsequently, the storage processing unit 59 issues a normal storage completion notification (S332), and returns to S301.

Hereinafter, a case where storage of delayed measured data is determined in S302 will be described. The storage processing unit 59 registers contents of the CSV file 121 generated in S220 and which includes delayed measured data in the delay table 620 of the DB 200 (S320). Subsequently, the storage processing unit 59 issues a delayed storage completion notification (S321), and returns to S301.

Hereinafter, a case where replacement of delayed measured data is determined in S302 will be described. The storage processing unit 59 identifies an original compressed file 122 including an unreceived time point matching the delayed measurement time point of S210 from the archive 300. In addition, the storage processing unit 59 replaces the identified original compressed file 122 in the archive 300 with the compressed file generated in S210 and which has been replaced with delayed measured data (S310), and returns to S301.

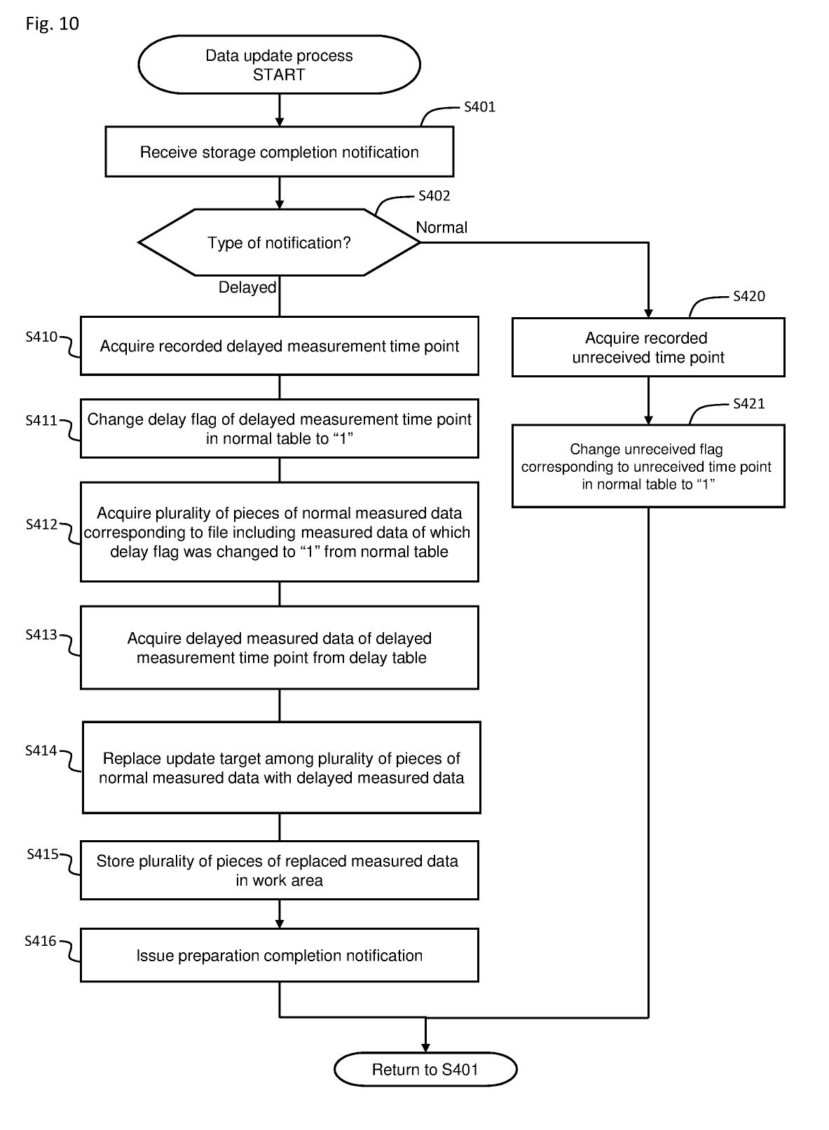

FIG. 10 is a flow chart showing an example of a data update process.

When the update processing unit 55 receives a storage completion notification (S401), the update processing unit 44 determines whether a type of the notification is a normal storage completion notification (the notification in S231) or a delayed storage completion notification (the notification in S221) (S402).

Hereinafter, a case where a normal storage completion notification is determined in S402 will be described. The update processing unit 55 acquires the unreceived time point recorded in S112 shown in FIG. 7 (S420). In the normal table 600 in the DB 200, the update processing unit 55 changes the unreceived flag 604 at the acquired unreceived time point to “1” (S421), and returns to S401.

Hereinafter, a case where a delayed storage completion notification is determined in S402 will be described. The update processing unit 55 acquires the delayed measurement time point recorded in S112 shown in FIG. 7 (S410). In the normal table 600 in the DB 200, the update processing unit 55 changes the delay flag 605 at the acquired delayed measurement time point to “1” (S411).

The update processing unit 55 acquires a plurality of pieces of normal measured data corresponding to the compressed file 122 including the measured data of which the delay flag 605 has been changed to “1” from the normal table 600 (S412). In other words, the update processing unit 55 acquires a plurality of pieces of normal measured data which constitute a unit of import and which includes the measured data of which the delay flag 605 has been changed to “1” from the normal table 600. The update processing unit 55 acquires delayed measured data having the delayed measurement time point acquired in S410 from the delay table 620 (S413).

The update processing unit 55 replaces normal measured data corresponding to the delayed measurement time point acquired in S410 among the plurality of pieces of normal measured data acquired in S412 with the delayed measured data acquired in S413 (S414). The update processing unit 55 stores the plurality of pieces of measured data after replacement (replaced measured data) in the work area 83 (S415).

The update processing unit 55 issues a preparation completion notification (S416), and returns to S401. The preparation completion notification is detected by the determination in S102 shown in FIG. 7.

The processes described above have the following working effects. (1) Measured data of which measurement time point is unreceived (in other words, an unreceived time point) is recorded in the normal table 600. (2) Delayed measured data of which unreceived time point has already been received is recorded in the normal table 600.

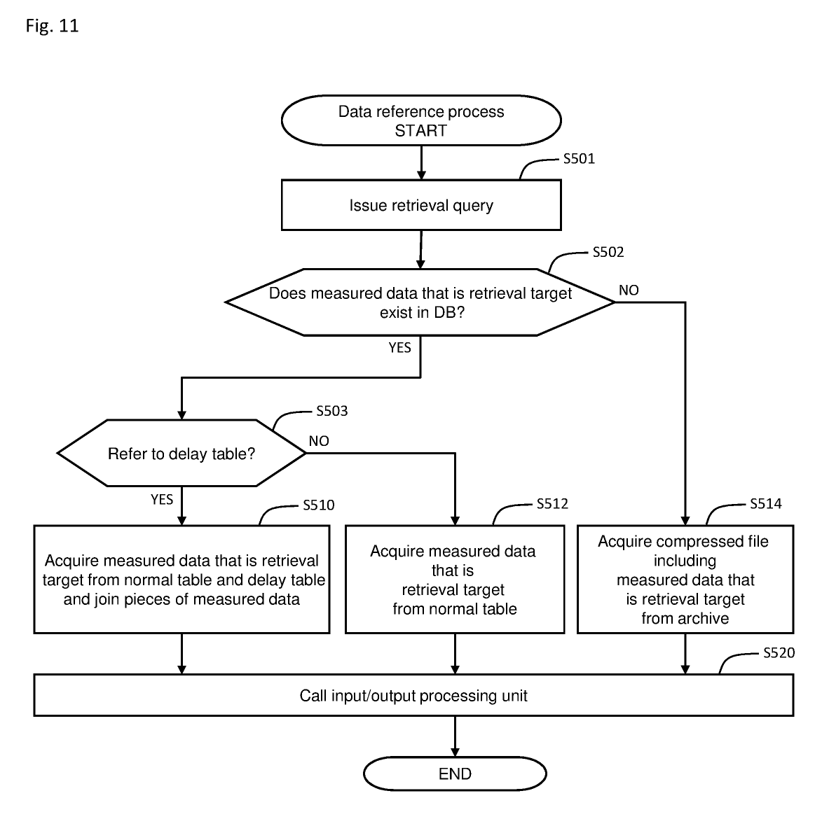

FIG. 11 is a flow chart showing an example of a data reference process.

The reference processing unit 57 issues a retrieval query to the query processing unit 56 (S501). The retrieval query may be input from the user via the input/output processing unit 58.

The reference processing unit 57 determines whether or not measured data that is a retrieval target of the retrieval query exists in the DB 200 (S502). For example, the reference processing unit 57 determines whether or not a measurement time point specified by the retrieval query is within a storage period T2 of the DB 200.

When measured data that is the retrieval target does not exist in the DB 200 (S502: no), the reference processing unit 57 acquires a compressed file 320 including the measured data that is the retrieval target from the archive 300 (S514). In addition, the reference processing unit 57 extracts the measured data from the compressed file 320 and calls the input/output processing unit 58 (S520), and ends the process.

When the measured data that is the retrieval target exists in the DB 200 (S502: yes), the reference processing unit 57 determines whether or not a present configuration is to refer to the delay table 620 (S503). This configuration may be set as appropriate by the user or may be set by default to the data integration apparatus 1.

When the present configuration is not to refer to the delay table 620 (S503: no), the reference processing unit 57 acquires the measured data that is the retrieval target from the normal table 600 (S512). Subsequently, the reference processing unit 57 calls the input/output processing unit 58 (S520), and ends the process.

When the present configuration is to refer to the delay table 620 (S503: yes), the reference processing unit 57 acquires the measured data that is the retrieval target from both the normal table 600 and the delay table 620 and joins the pieces of acquired measured data. In other words, the reference processing unit 57 replaces measured data of which the delay flag 605 is “1” among the pieces of measured data acquired from the normal table 600 with measured data acquired from the delay table 620. At this point, the reference processing unit 57 need not acquire measured data of which the unreceived flag 604 is “1” from the normal table 600. Subsequently, the reference processing unit 57 calls the input/output processing unit 58 (S520), and ends the process.

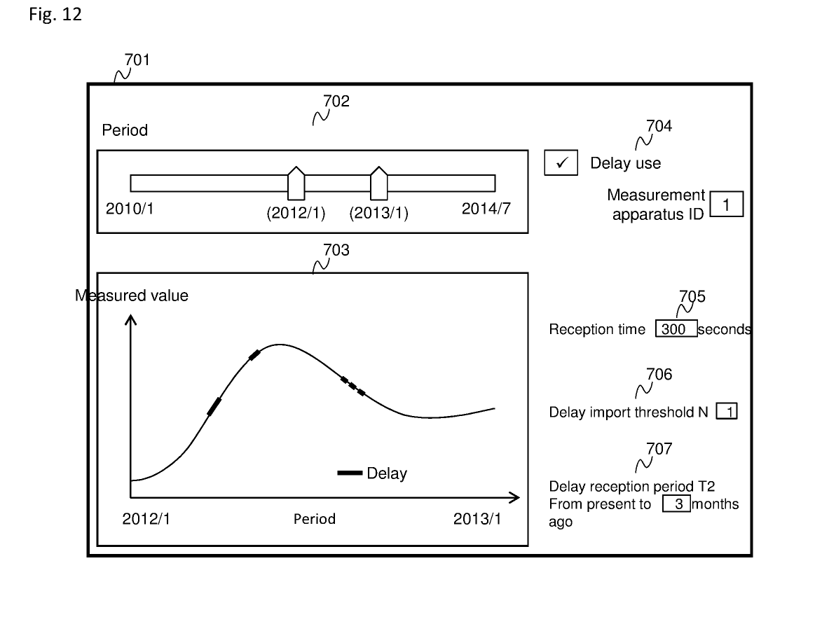

FIG. 12 is a schematic diagram showing an example of a measured data GUI 701. The measured data GUI 701 may be generated and displayed by the input/output processing unit 58.

The measured data GUI 701 displays a change in measured values within a prescribed period. For example, the measured data GUI 701 includes a period configuration area 702 for configuring a period to be displayed and a measured value display area 703 for displaying a change in measured values as a graph.

In addition, the measured data GUI 701 may include a delay use selection area 704 for selecting whether or not to use delayed measured data. Specifically, when the delay use selection area 704 is configured to “off”, only the measured value 603 of the normal table 600 is used and the measured value 623 of the delay table 620 is not used. When the delay use selection area 704 is configured to “on”, the measured value 623 of the delay table 620 is used with respect to the measured value 603 of the normal table 600 of which the delay flag 605 is “1”.

When the delay use selection area 704 is configured to “off”, a graph to which an interpolation value is applied instead of a measured value of delayed measured data may be displayed in the measured value display area 703, and when the delay use selection area 704 is configured to “on”, a graph to which a measured value of delayed measured data is applied may be displayed in the measured value display area 703. In this case, a location where a measured value of delayed measured data is applied may be displayed in a mode that enables the location to be distinguished from other locations (such as a different color).

The measured data GUI 701 may include an area for configuring a parameter related to integration of measured data. For example, the measured data GUI 701 may include a configuration area 705 for configuring a reception time.

In addition, the measured data GUI 701 may include a configuration area 706 for configuring a threshold N (which corresponds to the threshold N of the determination of S114 in FIG. 7) used to determine whether or not to issue an import indication when several pieces of delayed measured data are stored in the delay buffer 82. For example, when the configuration area 706 is configured to “2”, a determination of “no” is made in S114 when only one piece of delayed measured data is stored in the delay buffer 82.

Furthermore, the measured data GUI 701 may include a configuration area 707 for configuring a period T2 (which corresponds to S111 in FIG. 7) for determining whether to register delayed measured data in the delay table 620 or to discard the delayed measured data. For example, when the configuration area 707 is set to the effect that the period T2 is interlocked with the DB storage period, a determination of “no” is made in S111 with respect to delayed measured data of which a measurement time point precedes the DB storage period. For example, when the period T2 is configured to “3 months” in the configuration area 707, a determination of “no” is made in S111 with respect to delayed measured data of which a measurement time point precedes the current time point by 3 months or more.

The embodiment described above merely represents an example for illustrating the present invention, and it is to be understood that the scope of the present invention is not limited to the embodiment. It will be obvious to those skilled in the art that the present invention can be implemented in various other modes without departing from the spirit of the present invention.

While time-series data based on measurement time points has been described above as an example of data having an order relationship, the data having an order relationship may be data of other series. For example, the data having an order relationship may be series data based on time stamps, a counter, or the like.

At least one of the first storage apparatus 12 and the second storage apparatus 13 may be constituted by a RAID (redundant array of inexpensive disks). The data processing unit 52 may include two or more normal buffers 81 and may switch normal buffers used as a storage destination of measured data for each reception time. Both the first storage unit and the second storage unit may be constituted by a DB.

In addition, for example, a correspondence between a plurality of reception times and a plurality of order sections (time intervals) may be managed by a table or may be identified by calculation. Furthermore, reception times and order sections (time intervals) may have one-to-one correspondence. Therefore, an order belonging to an order section (a time point belonging to a time interval) may be interpreted as an order (a time point) belonging to a reception time.

### REFERENCE SIGNS LIST

1 Data integration apparatus
52 Data processing unit
53 Import processing unit
54 Interpolation processing unit
55 Update processing unit
56 Query processing unit
57 Reference processing unit
58 Input/output processing unit
59 Storage processing unit
200 Database
300 Archive

1. A data integration apparatus, comprising:
an interface configured to receive data having an order relationship at each of a plurality of reception times; and
a controller configured to store, in a first storage unit, normal data that is data in an order belonging to a selected reception time among pieces of data received by the interface and an unreceived order that is an order not corresponding to any data order of data received at the selected reception time among a plurality of orders belonging to the selected reception time.

2. The data integration apparatus according to claim 1, wherein the controller is configured to, when an order of delayed data that is data received after the selected reception time matches any of unreceived orders stored in the first storage unit, store the delayed data in the first storage unit.

3. The data integration apparatus according to claim 1, wherein the controller is configured to preferentially delete data with lower orders when deleting data stored in the first storage unit, and
the controller is configured not to store the delayed data in the first storage unit when an order of the delayed data is lower than a lowest order stored in the first storage unit.

4. The data integration apparatus according to claim 3, wherein the controller is configured to:
store the normal data, to be stored in the first storage unit, also in a second storage unit with a lower input and output performance of data than the first storage unit; and
when storing the delayed data in the first storage unit, with respect to an unreceived order matching the delayed data among the unreceived orders stored in the first storage unit, update information indicating whether or not delayed data matching the unreceived order has already been received so as to indicate that the delayed data has already been received and, at the same time, store the delayed data also in the second storage unit.

5. The data integration apparatus according to claim 4, wherein the normal data and the delayed data are distinguished from each other in the first storage unit.

6. The data integration apparatus according to claim 5, wherein the controller is configured to generate interpolated data corresponding to the unreceived order based on a prescribed interpolation process and store the interpolated data in the first storage unit and the second storage unit as the normal data.

7. The data integration apparatus according to claim 6, wherein the controller is configured to, when storing the delayed data in the second storage unit, identify interpolated data of an unreceived order matching the delayed data from the second storage unit and replace the identified interpolated data with the delayed data.

8. The data integration apparatus according to claim 7, wherein
the first storage unit is a database or a first storage apparatus which stores the database, and
the second storage unit is a file system or a second storage apparatus which stores the file system.

9. The data integration apparatus according to claim 8, wherein the controller is configured to, when storing the delayed data in the second storage unit, acquire an original file including data of an unreceived order matching the delayed data from the second storage unit, generate a replaced file by replacing interpolated data of the unreceived order in the acquired original file with the delayed data, and replace the original file in the second storage unit with the generated replaced file.

10. The data integration apparatus according to claim 1, wherein the data having an order relationship is time-series data based on time points at which pieces of data are measured, and the order is a time point at which each piece of data is measured.

11. The data integration apparatus according to claim 1, wherein the controller is configured not to store delayed data corresponding to the unreceived order in the first storage unit when the delayed data is received after a lapse of a prescribed time from a reception time corresponding to the unreceived order.

12. The data integration apparatus according to claim 1, wherein the controller is configured to store the delayed data that is data received after the selected reception time in the first storage unit as well as in a second storage unit with a lower input and output performance of data than the first storage unit.

13. The data integration apparatus according to claim 13, wherein the normal data and the delayed data are distinguished from each other in the first storage unit.

14. A data integration method, comprising:
when an interface receives data having an order relationship at each of a plurality of reception times,
causing a controller to store, in a first storage unit, normal data that is data in an order belonging to a selected reception time among pieces of data received by the interface and an unreceived order that is an order not corresponding to any data order of data received at the selected reception time among a plurality of orders belonging to the selected reception time.
